(19) United States
(12) Patent Application Publication
(10) Pub. No.: US 2026/0259895 A1
(43) Pub. Date: Sep. 3, 2026

(54) AUTOMATED RELATIONSHIP DISCOVERY

(71) Applicant: INTUIT INC., Mountain View, CA (US)

(72) Inventors: Bin LI, San Jose, CA (US); Nazanin Zaker HABIBABADI, Sunnyvale, CA (US); Atanu ROY, Dublin, CA (US)

(21) Appl. No.: 19/066,302

(22) Filed: Feb. 28, 2025

(51) Int. Cl. G06F 16/28; G06F 16/22

(52) U.S. Cl. CPC G06F 16/288; G06F 16/2264

(57) ABSTRACT

The present disclosure provides techniques for automated relationship discovery. One example method includes receiving input data indicative of a plurality of heterogeneous data entries, wherein the plurality of heterogeneous data entries indicate a type of subjects, generating, for each heterogeneous data entry in the plurality of heterogeneous data entries, an individual graph, wherein nodes of the plurality of individual graphs represent the type of subjects, and wherein the nodes indicate a plurality of attributes, generating a unified graph based on the plurality of individual graphs, receiving an indication associated with a particular node in the unified graph, identifying a set of neighboring nodes associated with particular node, determining an action to be applied to the particular node, and applying the action to each node in the set of neighboring nodes.

### INTRODUCTION

Aspects of the present disclosure relate to automated relationship discovery.

Data analysis methods have gained popularity due to their capacity to model complex relationships. Organizations frequently depend on distinct data sources to power their data analysis methods for relationship discovery. However, the various formats of heterogeneous data from the distinct data sources presents considerable difficulties in finding relationships. For instance, heterogeneous data kept in various data sources cannot be readily compared, combined, or aggregated through traditional methods, which frequently have difficulty addressing semantic, structural, and contextual differences in the heterogeneous data. The difficulty in processing the heterogeneous data causes inefficiencies in automated relationship discovery.

Accordingly, improved systems and methods are needed for automated relationship discovery.

### BRIEF SUMMARY

Certain embodiments provide a method for automated relationship discovery.

The method generally includes receiving input data indicative of a plurality of heterogeneous data entries, wherein the plurality of heterogeneous data entries indicate a type of subjects, generating, for each heterogeneous data entry in the plurality of heterogeneous data entries, an individual graph, wherein nodes of the plurality of individual graphs represent the type of subjects, and wherein the nodes indicate a plurality of attributes, generating a unified graph based on the plurality of individual graphs, receiving an indication associated with a particular node in the unified graph, identifying a set of neighboring nodes associated with particular node, determining an action to be applied to the particular node, and applying the action to each node in the set of neighboring nodes.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of the various embodiments.

### BRIEF DESCRIPTION OF DRAWINGS

The appended figures depict certain features of the various aspects described herein and are not to be considered limiting of the scope of this disclosure.

FIG. 1 depicts an example predictive model for automated relationship discovery.

FIG. 2 depicts an example process for monitoring relationship discovery.

FIG. 3 is a flow diagram of example operations for automated relationship discovery.

FIG. 4 depicts an example application server related to embodiments of the present disclosure.

### DETAILED DESCRIPTION

Aspects of the present disclosure provide apparatuses, methods, processing systems, and computer-readable mediums for automated relationship discovery.

Organizations increasingly utilize heterogeneous data from distinct data sources, including relational databases, graph databases, spreadsheets, and unstructured text, to model relationships for decision-making. However, the heterogeneous data from various data sources usually cannot be readily processed in a unified manner through traditional methods. Existing techniques would require extensive human supervision to handle the differences of meaning, form, or context indicated in the heterogeneous data, resulting in inefficiencies in automated relationship discovery.

Techniques described herein address these challenges through converting and harmonizing heterogeneous data entries from distinct data sources (e.g., of different forms as represented using different data structures or schemas) into readily accessible data for efficient relationship discovery.

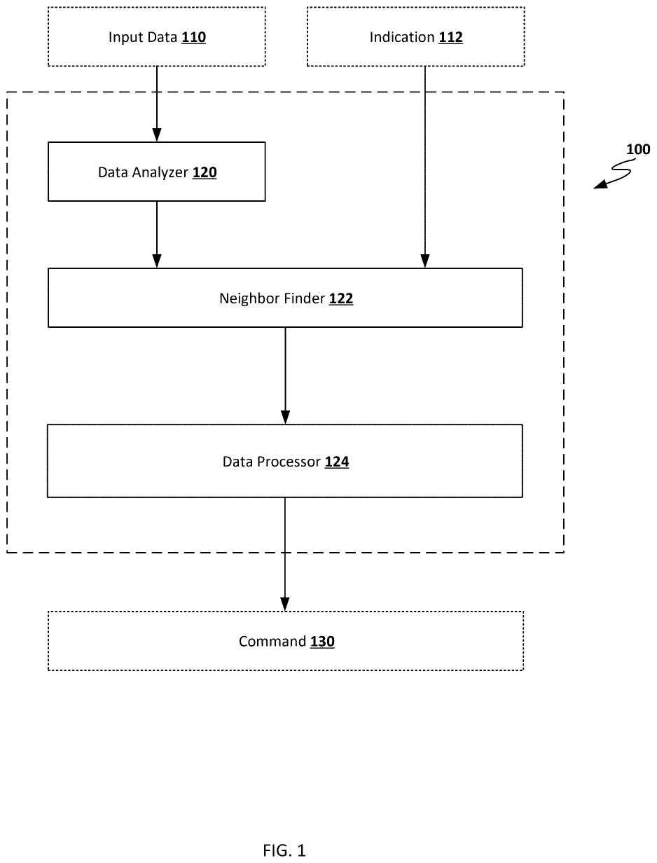

The readily accessible data may be represented via a unified graph. For example, information in heterogeneous data from each distinct data source can be organized with respect to a type of subjects (e.g., merchants, customers, suppliers, payees, and/or the like) to form an individual graph, where each node represents a subject. The information can be grouped according to the attributes indicated in the heterogeneous data. Edges between a pair of nodes can be created if the pair of nodes have some degree of connectivity (e.g., sharing a common value for an attribute). Accordingly, the individual graphs can be aggregated to form the unified graph, where nodes representing the same subject can be consolidated and edges between nodes can be combined. Details regarding creating a unified graph can be found below with respect to FIG. 1.

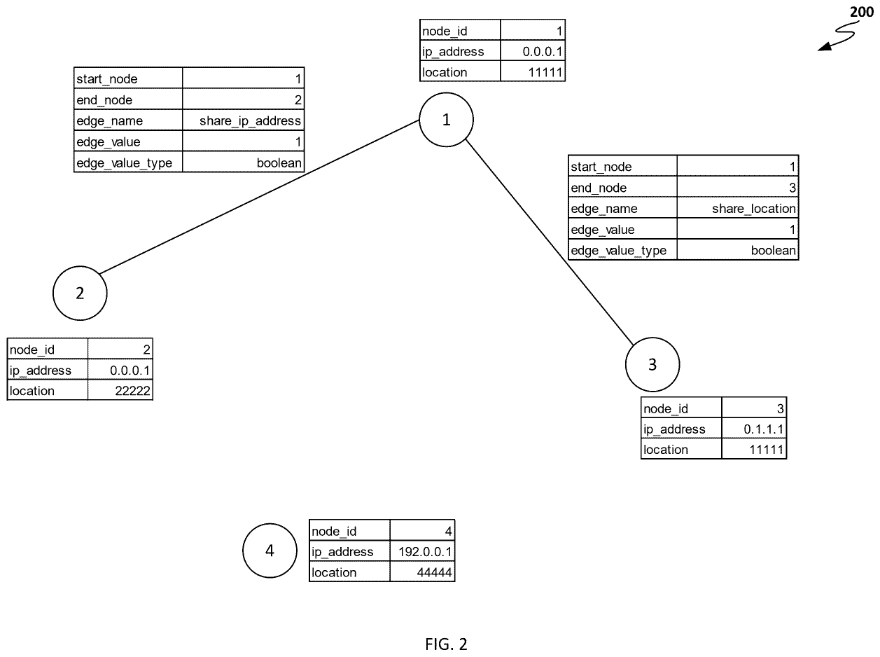

Furthermore, based on the information stored in the nodes, additional edges can be created between nodes. For example, an additional edge may indicate whether two nodes have a common characteristic (e.g., sharing a set of items or a common interaction with an item). Details regarding creating additional edges can be found below with respect to FIGS. 1-2.

Specific attributes stored in nodes or edges of the unified graph may be excluded based on a downstream analysis task. For example, in a downstream task to identify groups of nodes sharing geographical locations, information about payments made by the nodes may be excluded. Excluding some information can simplify the analysis and reduce the computational costs for the downstream task, resulting in efficient automated relationship discovery.

Additionally, for streamlined downstream analysis, edges between a pair of nodes can be combined as a unified edge. The unified edges may reduce the computing resources required to identify groups of neighboring nodes, which may be closely related (e.g., sharing many common characteristics).

Once a group of neighboring nodes are found, an action to be applied to one node in the group may then be applied to every node in the group. Details regarding creating unified edges and finding groups of neighboring nodes can be found below with respect to FIGS. 1-2.

By converting heterogeneous data into a unified flexible graph representation, techniques described herein overcome deficiencies in existing techniques for automated relationship discovery. For example, while existing techniques rely heavily on ad hoc processing of heterogeneous data, techniques described herein allow systematic and streamlined analysis of heterogeneous data. Second, creating additional edges based on processing information stored in the nodes helps to highlight similarities between nodes, making the automated relationship discovery more robust. Furthermore, by excluding specific attributes based on downstream task requirements through techniques described herein, significant cost savings can be achieved with great reductions in computational, monitoring, and transactional costs. Thus, embodiments of the present disclosure provide a technical improvement with respect to conventional techniques for automated relationship discovery.

### Example Predictive Model for Automated Relationship Discovery

FIG. 1 depicts an example predictive model 100 for automated relationship discovery. Predictive model 100 can receive input data 110 and indication 112 and generate command 130 as the output. Predictive model 100 can be deployed either online or offline.

Input data 110 can indicate a type of subjects (e.g., merchants, customers, suppliers, payees, and/or the like). Input data 110 may also indicate heterogeneous data entries of different format, such as matrices, tables (e.g., Pandas DataFrames), dictionaries, lists, JavaScript Object Notation (JSON) objects, graphs, unstructured texts, and/or the like.

Input data 110 may include heterogeneous data entries from multiple distinct data sources (e.g., different databases). For example, input data 110 may include a bipartite graph extracted from a graph database and a table extracted from a relational database.

In other words, input data 110 may include data entries from multiple distinct data sources about the type of nodes. The distinct data sources may indicate heterogeneous data organized according to distinct data structures, forms, or schemas. For example, if two nodes represent two people, input data 110 can include data about interactions (e.g., direct messages, comments of the posts, emails, etc.) between the two people at different platforms (e.g., social network platforms such as Facebook® or X®).

Indication 112 may indicate a particular subject (e.g., through an identifier). Details regarding indication 112 can be found below.

Input data 110 can be provided to data analyzer 120 to reorganize and generate a unified graph. For example, data analyzer 120 can first identify heterogeneous data entries indicated in input data 110. Each heterogeneous data entry can be converted into an individual graph with nodes representing the type of subjects indicated by input data 110. For simplicity, in the following discussion, the type of subjects indicated in input data 110 is assumed to be “merchant.”

Converting the heterogeneous data entry into an individual graph may utilize the particular data structure of the data entry. In an example, for a table type data entry, the data entry can be grouped by the “merchant” column (e.g., indicated by “merchantID”), and the other columns (e.g., “location”, “transaction_amount”, “frequency”, and/or the like) can be converted into attributes for the “merchant” column. Accordingly, the individual graph for the table type data entry can have “merchant” nodes indicating various attributes. In another example, information from unstructured texts can be extracted using machine learning tools, such as a large language model.

Additionally, an edge can be created in the individual graph to indicate a degree of connectivity between nodes with respect to an attribute. Following the example above, if a pair of nodes share a common customer, as indicated by values in a “customer” attribute, an edge indicating common customers can be created between the pair of nodes. The edge may be indicated as a binary value indicating the connection (e.g., share_common_customer=1), a weight indicating connection strength, or an aggregate of information (e.g., num_shared_customers).

In some examples, additionally or alternatively, some attributes reside in the edges. For example, when converting a bipartite graph with “merchant” and “customer” nodes into an individual graph with “merchant” nodes (e.g., using 2-hop connections), information stored in a “customer” node may be converted into attributes attached to the “merchant” nodes connected to the “customer” node in the bipartite graph, or attributes associated with edge(s) between the “merchant” nodes.

Data analyzer 120 may create a unified graph G_{M}=∪ᵢ₌₁ⁿ{G₁, G₂, . . . , Gₙ}, where each graph Gᵢ represents an individual graph and where unified graph G_{M} is an union of the nodes and edges of the individual graph Gᵢs. All individual graph Gᵢs have the same type of nodes (e.g., “merchant” nodes).

Nodes V_{M} of G_{M} may be the union of all nodes from individual graph Gᵢs. Similarly, the attributes of nodes V_{M} may be the aggregate (e.g., via concatenation) of all attributes of Vᵢ from individual graph Gᵢs.

A node may be identified by an identifier associated with the represented subject. However, if two nodes in two individual graph Gᵢs indicate the same subject but have two different identifiers, the identifier for two nodes may be updated to indicate a common value via similarity analysis based on the attributes of the two nodes. The discussion follows assumes that the individual graphs have the same identifier for a particular node.

In each individual graph Gᵢ, an edge Eᵢ may indicate a degree of connectivity. The degree of connectivity can be indicated as a binary value (e.g., indicating whether or not there is a connection between two nodes), a weight indicating connection strength (e.g., as a float), or an aggregate (e.g., a concatenation) of multiple indication of relationships, such as the size of common attribute values (e.g., number of common customers), the volume of inner flow, and so on, as discussed above.

An edge E_{M} may be a union of all edges Eᵢs from individual graphs. For example, the union may be represented via an aggregated list. In an example, an edge E_{M} between node a and node b in the unified graph GM may be represented as E_{M}(Vₐ, V_{b})=[E₁, E₂, . . . , Eₙ]. Alternatively, the edge E_{M} may be a unified edge representing the connection strength aggregated from all edges Eᵢs from individual graph Gᵢs.

Additionally, before generating E_{M}s, data analyzer 120 can create additional edges based on the attributes indicated in the nodes or edges of the individual graphs. Data analyzer 120 may first create new attributes based on based on attributes of the nodes or the existing edges connected to the nodes. If two nodes share a new attribute, an edge connecting the two nodes may then be created. The additional edges can be added to the set of edges Eᵢs to generate the edge E_{M}.

In an example, the nodes may indicate an “ip_address” attribute, and data analyzer 120 can create an indicator function of the attribute as a new attribute “share_ip_address,” which may be a binary indication of whether two nodes share the same IP address. Accordingly, a new edge may be created between two nodes with the “share_ip_address” attribute if the two nodes share the same IP address.

In another example, the edges may indicate employee information (e.g., employee names), where the nodes themselves do not necessarily indicate such information, and data analyzer 120 can create an attribute “common_employee_count” indicating a number of employees that are common between two nodes. In other words, the additional edges may be created based on information external to the nodes (e.g., attributes of the existing edges). Accordingly, a new edge may be created between two nodes with the “common_employee_count” attribute if the two nodes have common employee(s).

In yet another example, the nodes and/or existing edges may indicate an “employee_count” attribute (e.g., by aggregating the number of employees for a node), and data analyzer 120 can create an attribute “total_employee_count,” a numerical value indicating the total number of employees between two nodes. Accordingly, a new edge may be created between two nodes with the “total_employee_count” attribute showing the total number of employees of the two nodes.

In some examples, data analyzer 120 creates the new attributes using tools with configurable rules for feature generation, such as Deep Feature Synthesis in the featuretools package. In some examples, additionally or alternatively, data analyzer 120 creates the new attributes using tools capable of extracting and synthesizing information, such as a large language model.

In some examples, data analyzer 120 aggregates edges with similar properties and generate, in place, an edge indicating a statistical summary of the edges with similar properties. For example, two “merchant” nodes may share a same customer but have multiple distinct edges with attributes indicating purchase amounts, and data analyzer 120 may aggregate the distinct edges between the “merchant” nodes to generate an edge indicating summary statistics, such as a mean purchase amount, a standard deviation of the purchase amounts, and so on.

In some examples, an edge E_{M} can be a multidimensional vector, where each vector represent an edge Eᵢ. For example, an edge Eᵢ can be converted into a vector (e.g., using embedding tools, such as a Bidirectional Encoder Representations from Transformers (BERT), word2vec, or a transformer). The embedding vector representing the edges Eᵢs can then be combined (e.g., concatenated) into a multidimensional vector. Converting edges with different attributes and values into a uniform representation further contributes to storage efficiency and computational efficiency downstream while preserving the rich contextual information in the various attributes.

As discussed above, the edge E_{M} may be a unified edge representing the connection strength aggregated from all edges Eᵢs from individual graph Gᵢs. Sometimes the number of attributes is simply too large to be efficiently processed. To streamline the downstream analysis, the degrees of connectivity under the attributes can be aggregated.

In some examples, the unified edge indicates a unified weight that is computed based the degrees of connectivity. For example, the unified weight can be a weighted average of the degrees of connectivity. In such examples, the unified weight is normalized based on a configured range (e.g., as float-type weights or binary indications).

In some examples, additionally, the unified weight may be generated using a machine learning model, such as a linear regression model, a logistic regression model, a support vector machine, a neural network, or the like. Accordingly, the weighted average may be based on the weights of the machine learning model.

The unified graph and indication 112 can be provided to neighbor finder 122 to identify a set of neighboring nodes related to the particular subject. Indication 112 may indicate a particular node representing the particular subject (e.g., through an identifier associated with the particular subject). Accordingly, the set of neighboring nodes would include the particular node.

In some examples, a particular neighbor finding task may be configured (e.g., indicated via indication 112 or configured though neighbor finder 122), such as finding the most similar merchants, finding merchants sharing a geographical location for physical stores, finding merchants sharing a common employee base, or finding merchants sharing a common customer base.

Based on the task specified, neighbor finder 122 can excludes one or more attributes from the unified graph. For example, for the task to find merchants sharing a geographical location for physical stores, attributes related to employees may not be as helpful or relevant and may be ignored. In some examples, the attribute to exclude is identified based on a machine learning model or an embedding generator, such as a BERT, word2vec, or a transformer.

In some examples, alternatively, neighbor finder 122 identifies groups of neighboring nodes prior to receiving indication 112. In such examples, upon receiving indication 112, neighbor finder 122 can identify, in the unified graph, a group of neighboring nodes that includes the particular node.

In some examples, a relatedness score is computed for each node in the unified graph other than the particular node, based on one or more of edges in the unified graph. If a node has a relatedness score meeting a threshold, the node can be included in the set of neighboring nodes.

In such examples, computing the relatedness score includes using one or more of a linear regression, a collaborative filtering model, a content-based filtering model, a k-means clustering algorithm, a density-based spatial clustering of applications with noise (DBSCAN) algorithm, a decision tree, a random forest, a neural network, a label propagation algorithm (LPA), or a rule-based model.

Details regarding finding a set of neighboring nodes can be found below with respect to FIG. 2.

The set of neighboring nodes can be provided to data processor 124 to generate command 130. Data processor 124 may first determine an action to be applied to the particular node. Accordingly, command 130 may correspond to the action but would be instead applied to each node in the group of neighboring nodes.

For example, the action may be determined based on an algorithm (e.g., a decision tree, a logistic regression model, a neural network and/or the like) or a user input.

In some examples, the action includes generating a recommendation associated with the set of neighboring nodes. The recommendation may indicate recommending an item to the nodes, recommending the nodes to a user, and/or the like. For example, the neighboring nodes may represent users of a software application, and content to be provided (e.g., via a user interface) to the user corresponding to the particular node may also be provided to other user(s) in the set of neighboring nodes.

### Example Process for Monitoring Relationship Discovery

FIG. 2 depicts an example process 200 for monitoring relationship discovery. Process 200 can be performed by a predictive model, such as predictive model 100 as shown in FIG. 1. Although process 200 can operate on graphs with existing edges, the example as depicted assumes that there is no existing edges.

Process 200 starts by receiving Nodes 1-4. Nodes 1-4 may be identified using their respective identifiers, such as “node_id” as depicted. As depicted, each node has several associated attributes that includes information about the nodes, such as “ip_address” and “location.” In this example, the attributes depicted may be the remaining attributes after some other attributes are excluded with respect to a task, as discussed with respect to FIG. 1. For example, the task in this example may relate to finding merchants sharing a common operating location.

In addition, additional attributes may be created (e.g., by a data analyzer, such as data analyzer 120 as shown in FIG. 1) based on information (e.g., attributes and attribute values) in the nodes or existing edges, if any, as discussed with respect to FIG. 1.

In this example, attributes “share_ip_address” and “share_location” are created based on the attributes “ip_address” and “location” as depicted.

In this example, Node 1 connects with Node 2 via an edge with attribute “share_ip_address,” while Node 1 connects with Node 3 via another edge with attribute “share location.”

In this example, the edge with attribute “share_ip_address” has a binary value of 1 as its degree of connectivity, the edge with attribute “share_location” also has a binary value of 1 as its degree of connectivity. If there is an additional edge (not illustrated) between Node 1 and Node 2, the additional edge can be aggregated with the edge with attribute “share_ip_address” as discussed with respect to FIG. 1. Similarly, if an additional edge is created between Node 1 and Node 3, the additional edge can be aggregated with the edge with attribute “share location.”

In this example, Node 2 and Node 3 are considered to be neighbors, even if there is no direct connection between Node 2 and Node 3. Similarly, as depicted, there is no edge between Node 4 and any of the Nodes 1-3. Accordingly, there are two distinct groups of nodes, one group including Nodes 1-3 and another group including Node 4.

If an indication for Node 2 is received, the set of neighboring nodes for Node 2 would include Nodes 1-3. Conversely, if an indication for Node 4 is received, the set of neighboring node for Node 4 would include Node 4 itself.

Accordingly, the same action can be applied to the same group of nodes as described with respect to FIG. 1. For example, if an action is to be applied to Node 2, the action may also be applied to each node in the set of neighboring nodes for Node 2, which are Nodes 1-3. Conversely, an action to be applied to Node 4 may be applied to Node 4 itself.

### Example Operations for Relationship Discovery

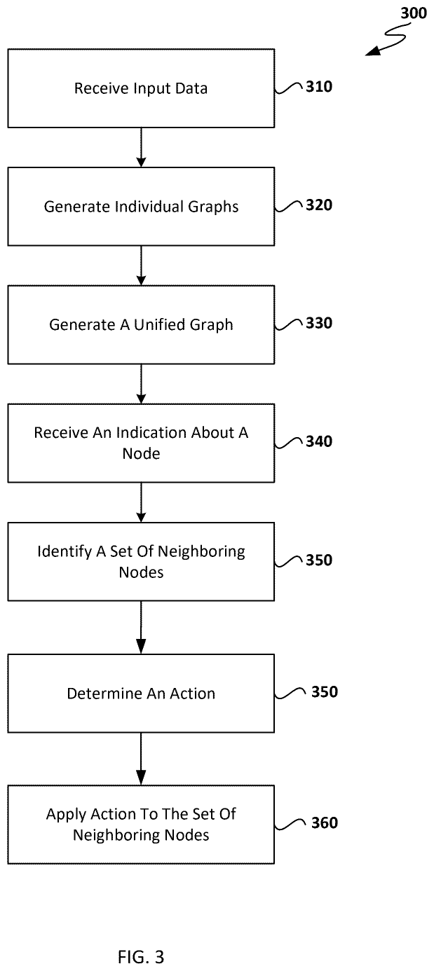

FIG. 3 is a flow diagram of example operations 300 for relationship discovery. Operations 300 may be performed by a predictive model, such as predictive model 100 as illustrated in FIG. 1.

Operations 300 begin at 310, where input data indicative of a plurality of heterogeneous data entries is received, wherein the plurality of heterogeneous data entries indicate a type of subjects. For example, the input data can be input data 110 as illustrated in FIG. 1.

At 320, an individual graph is generated for each heterogeneous data entry in the plurality of heterogeneous data entries, wherein nodes of the plurality of individual graphs represent the type of subjects, and wherein the nodes indicate a plurality of attributes. For example, the individual graphs can be the individual graphs discussed with respect to FIG. 1.

At 330, a unified graph is generated based on the plurality of individual graphs. For example, the unified graph can be the unified graph as described with respect to FIG. 1.

In some embodiments, generating the unified graph based on the plurality of individual graphs includes computing, for a pair of nodes, a unified weight based on edges in the individual graphs. For example, the unified weight can be the unified weight associated with a unified edge as described with respect to FIG. 1. In such embodiments, the unified weight may be normalized based on a configured range (e.g., as a float weight or a binary value), as described with respect to FIG. 1.

In some embodiments, alternatively, generating the unified graph based on the plurality of individual graphs includes combining, for a pair of nodes, edges in the individual graphs. For example, the combined edges can be the aggregated edges in the unified graph as described with respect to FIGS. 1-2. In such embodiments, additionally, the edges in the individual graphs are represented via embedding vectors while the aggregated edges are represented via multidimensional vectors.

At 340, indication associated with a particular node in the unified graph is received. For example, the indication can be indication 112 as illustrated in FIG. 1. In some embodiments, additionally, the indication indicates a task, such as a downstream task discussed with respect to FIG. 1.

At 350, a set of neighboring nodes associated with particular node is identified. For example, the set of neighboring nodes can be the set of neighboring nodes as discussed with respect to FIGS. 1-2.

In some embodiments, one or more attributes is excluded from the plurality of attributes based on a task. For example, excluding one or more attributes from the plurality of attributes may be specified through requirements of a downstream task, as discussed with respect to FIG. 1. Excluding some less relevant attributes can simplify the computational problem and reduce computational costs for finding the neighboring nodes.

In some embodiments, identifying the set of neighboring nodes associated with particular node includes computing, for a node other than the particular node in the unified graph, a relatedness score based on one or more of edges in the unified graph, determining that the relatedness score for the node meets a threshold, and including the node in the set of neighboring nodes based on determining that the relatedness score for the node meets the threshold. For example, the relatedness score may be the relatedness score discussed with respect to FIG. 1.

In such embodiments, computing the relatedness score includes using one or more of a linear regression model, a collaborative filtering model, a content-based filtering model, a k-means clustering, a decision tree, a random forest, a neural network, a label propagation algorithm (LPA), or a rule-based model.

At 360, an action is determined to be applied to the particular node. For example, the action can be the recommendation to be applied to the particular node as discussed with respect to FIG. 1 or the action to be applied to the Node 1 as described with respect to FIG. 2.

At 370, the action is applied to each node in the set of neighboring nodes. For example, the action can be the recommendation discussed with respect to FIG. 1 or applied to the Nodes 1-3 as described with respect to FIG. 2.

In some embodiments, applying the action to the action to each node in the set of neighboring nodes includes generating a recommendation associated with the set of neighboring nodes. For example, the recommendation can be recommending an item to the set of neighboring nodes, recommending the set of neighboring nodes to a user, and/or the like

### Example Application Server

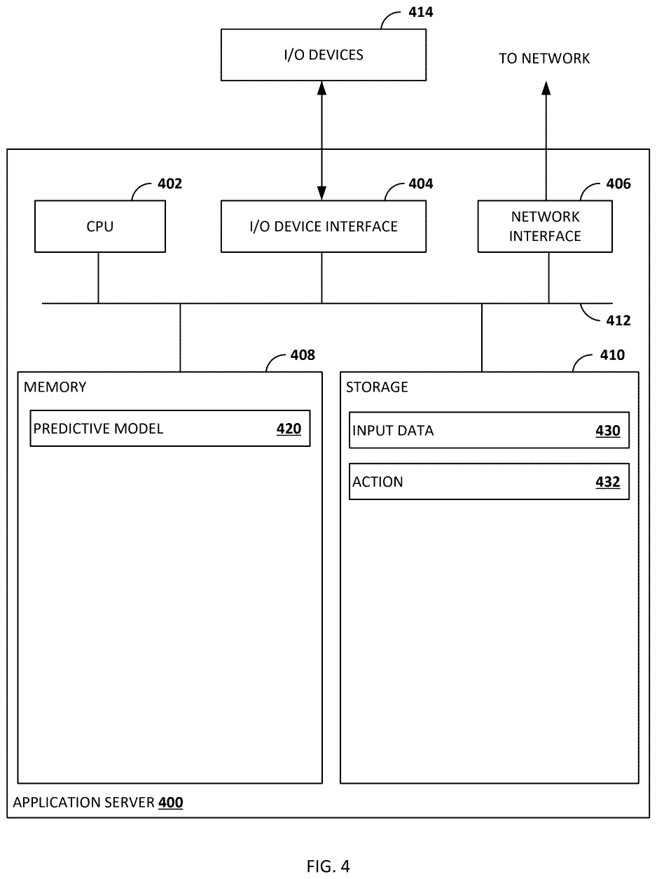

FIG. 4 depicts an example application server 400, which can be used to deploy predictive model 100 of FIG. 1. As shown, application server 400 includes a central processing unit (CPU) 402, one or more input/output (I/O) device interfaces 404, which may allow for the connection of various I/O devices 414 (e.g., keyboards, displays, mouse devices, pen input, etc.) to application server 400, a network interface 406, a memory 408, a storage 410, and an interconnect 412.

CPU 402 may retrieve and execute programming instructions stored in memory 408. Similarly, CPU 402 may retrieve and store application data residing in memory 408. Interconnect 412 transmits programming instructions and application data, among CPU 402, I/O device interface 404, network interface 406, memory 408, and storage 410. CPU 402 is included to be representative of a single CPU, multiple CPUs, a single CPU having multiple processing cores, and the like. I/O device interface 404 may provide an interface for capturing data from one or more input devices integrated into or connected to application server 400, such as keyboards, mice, touchscreens, and so on. Memory 408 may represent a random access memory (RAM), while storage 410 may be a solid state drive, for example. Although shown as a single unit, storage 410 may be a combination of fixed and/or removable storage devices, such as fixed drives, removable memory cards, network attached storage (NAS), or cloud-based storage.

As shown, memory 408 includes predictive model 420. Predictive model 420 may be the same as or substantially similar to predictive model 100 of FIG. 1. Predictive model 420 may be evaluated or trained using one or more graphics processing units (GPUs), such as a NVIDIA® H100, or similar devices, such as tensor processing units (TPUs).

As shown, storage 410 includes input data 430. Input data 430 may be the same as or substantially similar to input data 110 of FIG. 1 while action 432 may be the same as or substantially similar to the action as described with respect to FIGS. 1-2.

It is noted that the components depicted in application server 400 are included as examples, and other types of computing components may be used to implement techniques described herein. For example, while memory 408 and storage 410 are depicted separately, components depicted within memory 408 and storage 410 may be stored in the same storage device or different storage devices associated with one or more computing devices.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

1. A method, comprising:
receiving input data indicative of a plurality of heterogeneous data entries, wherein the plurality of heterogeneous data entries indicate a type of subjects;
generating, for each respective heterogeneous data entry in the plurality of heterogeneous data entries, an individual graph, wherein nodes of the plurality of individual graphs represent the type of subjects, wherein the nodes indicate a plurality of attributes, and wherein the attributes are generated based on providing each respective heterogenous data entry as input to an extraction machine learning model;
generating a unified graph based on the plurality of individual graphs, wherein generating the unified graph comprises generating a weight for an edge between a first node of a first individual graph and a second node of a second individual graph based on providing the first node and the second node as inputs to a scoring machine learning model trained to generate weights for a unified graph;
receiving an indication associated with a particular node in the unified graph;
identifying a set of neighboring nodes associated with particular node based on weighted edges between the particular node and the neighboring nodes; and
either:
generating a common recommendation for the particular node and a given node of the neighboring nodes; or
generating a recommendation indicating a given node of the neighboring nodes for the particular node.

2. The method of claim 1, wherein identifying the set of neighboring nodes associated with the particular node comprises:
determining that a weight between the particular node and a given neighboring node meets a threshold; and
including the given node in the set of neighboring nodes based on determining that the weight meets the threshold.

3. The method of claim 2, wherein the scoring machine learning model comprises one or more of a linear regression model, a collaborative filtering model, a content-based filtering model, a k-means clustering, a decision tree, a random forest, a neural network, a label propagation algorithm (LPA), or a rule-based model.

4. The method of claim 1, further comprising excluding one or more attributes from the plurality of attributes based on a task.

5. The method of claim 1, wherein generating the unified graph based on the plurality of individual graphs comprises:
computing, for a pair of nodes, a unified weight based on edges in the individual graphs.

6. The method of claim 5, further comprising:
normalizing the unified weight based on a configured range.

7. The method of claim 1, wherein generating the unified graph based on the plurality of individual graphs comprises:
combining, for a pair of nodes, edges in the individual graphs.

8. (canceled)

9. A system, comprising:
a memory including computer executable instructions; and
a processor configured to execute the computer executable instructions and cause the system to:
receive input data indicative of a plurality of heterogeneous data entries, wherein the plurality of heterogeneous data entries indicate a type of subjects;
generate, for each respective heterogeneous data entry in the plurality of heterogeneous data entries, an individual graph, wherein nodes of the plurality of individual graphs represent the type of subjects, [[and]] wherein the nodes indicate a plurality of attributes, and wherein the attributes are generated based on providing each respective heterogenous data entry as input to an extraction machine learning model;
generate a unified graph based on the plurality of individual graphs, wherein generating the unified graph comprises generating a weight for an edge between a first node of a first individual graph and a second node of a second individual graph based on providing the first node and the second node as inputs to a scoring machine learning model trained to generate weights for a unified graph;
receive an indication associated with a particular node in the unified graph;
identify a set of neighboring nodes associated with particular node based on weighted edges between the particular node and the neighboring nodes; and
either:
generate a common recommendation for the particular node and a given node of the neighboring nodes; or
generate a recommendation indicating a given node of the neighboring nodes for the particular node.

10. The system of claim 9, wherein identifying the set of neighboring nodes associated with the particular node comprises:
determining that a weight between the particular node and a given neighboring node meets a threshold; and
including the given node in the set of neighboring nodes based on determining that the weight meets the threshold.

11. The system of claim 10, wherein the scoring machine learning model comprises one or more of a linear regression model, a collaborative filtering model, a content-based filtering model, a k-means clustering, a decision tree, a random forest, a neural network, a label propagation algorithm (LPA), or a rule-based model.

12. The system of claim 9, wherein the processor is further configured to execute the computer executable instructions and cause the system to:
exclude one or more attributes from the plurality of attributes based on a task.

13. The system of claim 9, wherein generating the unified graph based on the plurality of individual graphs comprises:
computing, for a pair of nodes, a unified weight based on edges in the individual graphs.

14. The system of claim 13, wherein the processor is further configured to execute the computer executable instructions and cause the system to:
normalize the unified weight based on a configured range.

15. The system of claim 9, wherein generating the unified graph based on the plurality of individual graphs comprises:
combining, for a pair of nodes, edges in the individual graphs.

16. (canceled)

17. A non-transitory computer readable medium comprising instructions to be executed in a computer system, wherein the instructions when executed in the computer system cause the computer system to:
receive input data indicative of a plurality of heterogeneous data entries, wherein the plurality of heterogeneous data entries indicate a type of subjects;
generate, for each respective heterogeneous data entry in the plurality of heterogeneous data entries, an individual graph, wherein nodes of the plurality of individual graphs represent the type of subjects, wherein the nodes indicate a plurality of attributes, and wherein the attributes are generated based on providing each respective heterogenous data entry as input to an extraction machine learning model;
generate a unified graph based on the plurality of individual graphs, wherein generating the unified graph comprises generating a weight for an edge between a first node of a first individual graph and a second node of a second individual graph based on providing the first node and the second node as inputs to a scoring machine learning model trained to generate weights for a unified graph;
receive an indication associated with a particular node in the unified graph;
identify a set of neighboring nodes associated with particular node based on weighted edges between the particular node and the neighboring nodes; and
either:
generate a common recommendation for the particular node and a given node of the neighboring nodes; or
generate a recommendation indicating a given node of the neighboring nodes for the particular node.

18. The non-transitory computer readable medium of claim 17, wherein identifying the set of neighboring nodes associated with the particular node comprises:
determining that a weight between the particular node and a given neighboring node meets a threshold; and
including the given node in the set of neighboring nodes based on determining that the weight meets the threshold.

19. The non-transitory computer readable medium of claim 18, wherein the scoring machine learning model comprises one or more of a linear regression model, a collaborative filtering model, a content-based filtering model, a k-means clustering, a decision tree, a random forest, a neural network, a label propagation algorithm (LPA), or a rule-based model.

20. (canceled)
